(19) United States
(12) Patent Application Publication
(10) Pub. No.: US 2025/0314021 A1
(43) Pub. Date: Oct. 9, 2025

(54) ELECTRIC ROLLER

(71) Applicant: SAKAI HEAVY INDUSTRIES, LTD., Tokyo (JP)

(72) Inventors: Fusayoshi KOIKE, Saitama (JP); Noriyuki FUSHIMI, Saitama (JP); Daichi SHIBATA, Saitama (JP); Yuichiro YOSHIDA, Saitama (JP)

(73) Assignee: SAKAI HEAVY INDUSTRIES, LTD., Tokyo (JP)

(21) Appl. No.: 18/856,150

(22) PCT Filed: Apr. 6, 2023
(86) PCT No.: PCT/JP2023/014206

§ 371 Date: Oct. 11, 2024

(30) Foreign Application Priority Data
Apr. 14, 2022 (JP) 2022-067046

(51) Int. Cl. E01C 19/26; B60L 1/14; B60L 3/12; B60L 50/60

(52) U.S. Cl. CPC E01C 19/26; B60L 1/14; B60L 3/12; B60L 50/60; B60L 2200/40; B60L 2250/16

(57) ABSTRACT

An electric roller (1) includes: a pair of front and rear compaction wheels (a front wheel (R1) and a rear wheel (R2)); a vehicle frame (2) rotatably supporting the compaction wheels; at least one compaction-wheel electric motor (front-wheel electric motor (M1), right rear-wheel electric motor (M2), and left rear-wheel electric motor (R3)) to drive the compaction wheels; at least one compaction-wheel inverter (front-wheel inverter (J1), right rear-wheel inverter (J2), and left rear-wheel inverter (J3)) to control rotation speed of the compaction-wheel electric motor; at least one battery (K) to supply power to the compaction-wheel electric motor and compaction-wheel inverter; and a control unit (3) to output a signal to the compaction-wheel inverter according to a degree of inclination of a forward-backward lever (17), wherein the electric roller (1) has no internal combustion engine and uses only the battery (K) as a power source for the compaction wheels.

### TECHNICAL FIELD

The present invention relates to an electric roller.

### BACKGROUND OF THE INVENTION

Patent Document 1 exemplarily discloses a compaction vehicle (compaction roller) to compact a road surface. A conventional compaction roller includes a pair of compaction wheels, a vehicle frame, an engine, a hydraulic pump, and a hydraulic motor for moving. The conventional compaction roller moves with the hydraulic pump driven by the engine to cause hydraulic pressure to rotate the hydraulic motor for moving. Additionally, oil discharge pressure is controlled based on an input amount to a forward-backward lever to accelerate, decelerate, or stop the vehicle.

### PRIOR ART DOCUMENT

### Patent Document

Patent Document 1, Japanese Patent Application Publication No. 2010-149784 A.

### SUMMARY OF THE INVENTION

### Problems to be Solved

Efforts have recently been made worldwide to reduce emissions of greenhouse gases, which cause global warming, to zero for a decarbonized society. However, a conventional compaction roller uses an engine, so that fossil fuel is consumed and greenhouse gases such as CO₂ are emitted. In addition, using an engine makes a big noise and produces large amount of exhaust heat, to increase a burden on an operator in a closed space, such as a tunnel, and negative effects on work environment (people, structures, trees, and the like) at a construction site. Further, a conventional compaction roller has a problem of poor maintainability, such as leakage of hydraulic oil and increasing frequency of hydraulic oil replacement. Moreover, a compaction roller is desired to facilitate speed control.

Accordingly, the present invention is intended to provide an electric roller to facilitate speed control, contribute to a decarbonized society, improve work environment, and improve maintainability.

### Solution to Problems

An electric roller of the present invention includes: a pair of front and rear compaction wheels; a vehicle frame rotatably supporting the compaction wheels; at least one compaction-wheel electric motor to drive the compaction wheels; at least one compaction-wheel inverter to control rotation speed of the compaction-wheel electric motor; at least one battery to supply power to the compaction-wheel electric motor and compaction-wheel inverter; and a control unit to output a signal to the compaction-wheel inverter according to a degree of inclination of a forward-backward lever, wherein the electric roller has no internal combustion engine and uses only the battery as a power source for the compaction wheels.

The present invention allows for substantially eliminating fuel consumption and greenhouse gas emissions through electrification. Electrification also reduces noise and substantially eliminates greenhouse gas emissions, to allow for easing a burden on an operator and improving work environment. Additionally, there is no need to replace hydraulic oil, to have superior maintainability. The present invention utilizes the compaction-wheel inverter, to facilitate speed control.

In addition, it is preferable that the at least one compaction-wheel electric motor comprises two or more compaction-wheel electric motors.

The present invention helps increasing a prime torque, while preventing the compaction-wheel electric motor from increasing in size. This allows for stopping and starting the electric roller on a slope.

Further, it is preferable that the electric roller includes a potentiometer to detect a degree of inclination of the forward-backward lever, and outputs a detection result to the control unit.

The present invention includes the potentiometer, to allow for fine control based on a degree of inclination of the forward-backward lever.

Still further, it is preferable that the control unit outputs signals to the compaction-wheel inverter in two or more stages of an acceleration range, so that an aimed rotation speed of the compaction-wheel electric motor is gradually reached.

The present invention allows the rotation speed of the compaction-wheel electric motor to gradually reach the aimed rotation speed, to reduce unstable acceleration behavior due to excessive rotation.

Still further, it is preferable that the control unit outputs signals to the compaction-wheel inverter in two or more stages of a deceleration range, to gradually stop the electric roller.

The present invention prevents a vehicle body from being swung back, to allow for stably stopping a vehicle of the electric roller.

Still further, it is preferable that the electric roller is equipped with electrical components including a lamp and an alarm, and the at least one battery comprises two or more batteries having different voltages from each other and electrically connected to the compaction-wheel electric motor and the electrical components, respectively.

The present invention allows for suppling power in accordance with operating voltages of the components.

Still further, it is preferable that the battery is provided in at least one of a front space and a rear space of the vehicle frame.

The present invention allows for reducing the electric roller in size by way of effectively using space.

Still further, it is preferable that the electric roller is configured such that the electrical components, including the lamp, work even when the control unit has a system failure.

The present invention allows for raising an alert to those around, even with a system failure.

Still further, it is preferable that a display provided on a dashboard displays a speedometer, along with vehicle information kept in the control unit.

The present invention allows an operator to know other information on the vehicle, in addition to speed.

### Advantageous Effects of the Invention

The present invention facilitates speed control, contributes to a decarbonized society, improves work environment, and improves maintainability.

### BRIEF DESCRIPTION OF DRAWINGS

FIG. 1 is a side view of an electric roller according a first embodiment of the present invention;

FIG. 2 is a plan view of the electric roller according to the first embodiment;

FIG. 3 is a rear view of the electric roller according to the first embodiment;

FIG. 4 is a block diagram of a configuration of the electric roller according to the first embodiment;

FIG. 5 schematically illustrates operation of the electric roller according to the first embodiment;

FIG. 6 is a block diagram of a power supply system and a control system of the electric roller according to the first embodiment;

FIG. 7 is a rear view of a dashboard of the electric roller according to the first embodiment;

FIG. 8 is a side view of the dashboard of the electric roller according to the first embodiment;

FIG. 9 is a side view of a brake pedal of the electric roller according to the first embodiment when the roller moving forward;

FIG. 10 is a side view of the brake pedal, when depressed, of the electric roller according to the first embodiment;

FIG. 11 is a partially transparent side view of the electric roller according to the first embodiment;

FIG. 12 is a partially transparent plan view of the electric roller according to the first embodiment;

FIG. 13 is a cross-sectional view of a front wheel of the electric roller according to the first embodiment;

FIG. 14 is a plan view of a first gear box of the electric roller according to the first embodiment;

FIG. 15 is a cross-sectional view, taken along a line XV-XV in FIG. 14;

FIG. 16 is a cross-sectional view, taken along a line XVI-XVI in FIG. 14;

FIG. 17 is a cross-sectional view of, and around, rear wheels of the electric roller according to the first embodiment;

FIG. 18 is a cross-sectional view, taken along a line XVIII-XVIII in FIG. 17;

FIG. 19 is a side view of a steering system of the electric roller according to the first embodiment;

FIG. 20 is a plan view of the steering system of the electric roller according to the first embodiment;

FIG. 21 shows a chart indicating a relationship between time and rotation speed at a start time with a comparative case;

FIG. 22 shows a chart indicating a relationship between time and rotation speed at a stop time with the comparative case;

FIG. 23 shows a chart indicating drive command values for the compaction-wheel electric motor with the comparative case and the embodiment, as a relationship between time and rotation speed;

FIG. 24 shows a chart indicating a relationship between time and rotation speed at a start time with the embodiment;

FIG. 25 shows a chart indicating a relationship between time and rotation speed at a stop time with the embodiment; and

FIG. 26 shows a chart indicating drive command values for the compaction-wheel electric motor with a modification, as a relationship between time and rotation speed.

### EMBODIMENTS OF THE INVENTION

### First Embodiment

A description is given in detail of an electric roller of the present invention, with reference to the drawings. Embodiments and modifications as described below are merely examples, and the embodiments and modifications may be combined with each other as appropriate. An up-down direction, a right-left direction, and a front-rear direction shown in the drawings are based on a moving direction of the electric roller.

### <Schematic Overall Configuration>

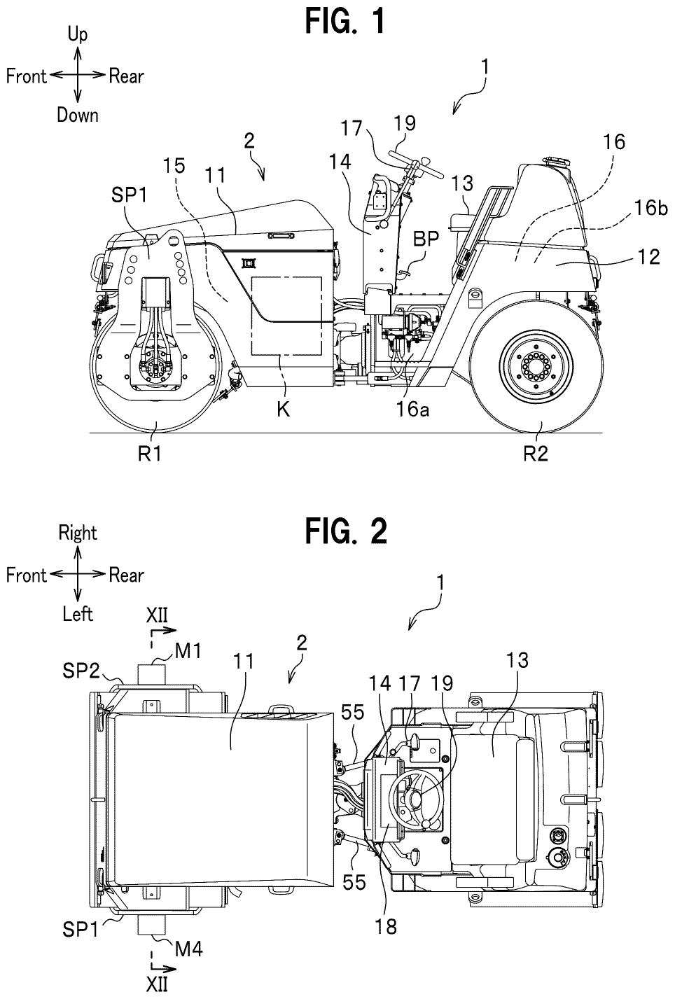

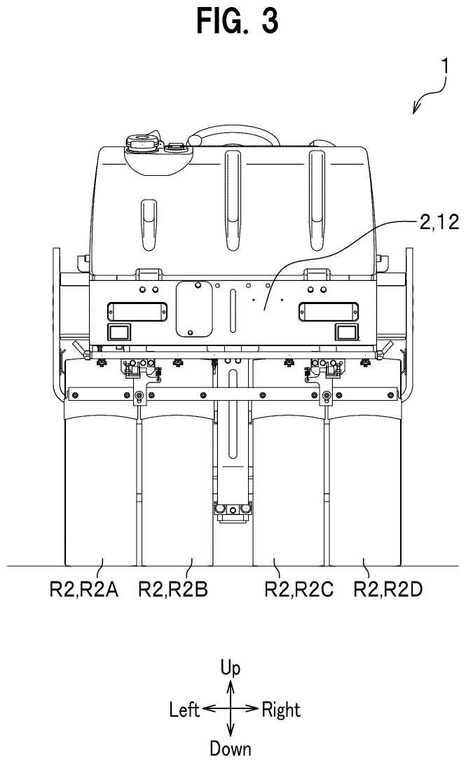

As shown in FIGS. 1 to 4, an electric roller 1 includes a front wheel R1, a rear wheel R2, a vehicle frame 2, an electric motor M (M1 to M4), an inverter J (J1 to J4), a battery K (K1 to K3), and a control unit 3.

The front wheel R1 is rotatably supported by a pair of front-wheel side plates SP1 and SP2 provided at a front of the vehicle frame 2. The front wheel R1 is a compaction wheel to compact a road surface, and is composed of an iron wheel as a single piece in the present embodiment. The front wheel R1 may be composed of two or more tires or may be composed of two or more iron wheels.

The rear wheel R2 is rotatably supported by a rear of the vehicle frame 2. The rear wheel R2 is a compaction wheel to compact a road surface, and is composed of four tires (R2A, R2B, R2C, and R2D) in the present embodiment. The rear wheel R2 may be composed of one or more iron wheels.

The vehicle frame 2 is a vehicle body to rotatably support the front wheel R1 and rear wheel R2. The vehicle frame 2 includes a front frame 11, a rear frame 12, a driver's seat 13, and a dashboard 14. The front frame 11 has front-wheel side plates SP1 and SP2 fixed to a front thereof. The front frame 11 is formed therein with a front space 15 to accommodate the inverter J and the battery K. The rear frame 12 includes the driver's seat 13 and the dashboard 14, and is formed therein with a rear space 16 to accommodate the electric motor M, the inverter J, a gear box, and the like. The rear space 16 includes a first rear space 16a formed under a floor with the driver's seat 13, and a second rear space 16b formed under the driver's seat 13. The front frame 11 is connected with the rear frame 12 via a joint pin extending in a vertical direction. The electric roller 1 of the present embodiment is of an articulated type, but may be of a rigid type.

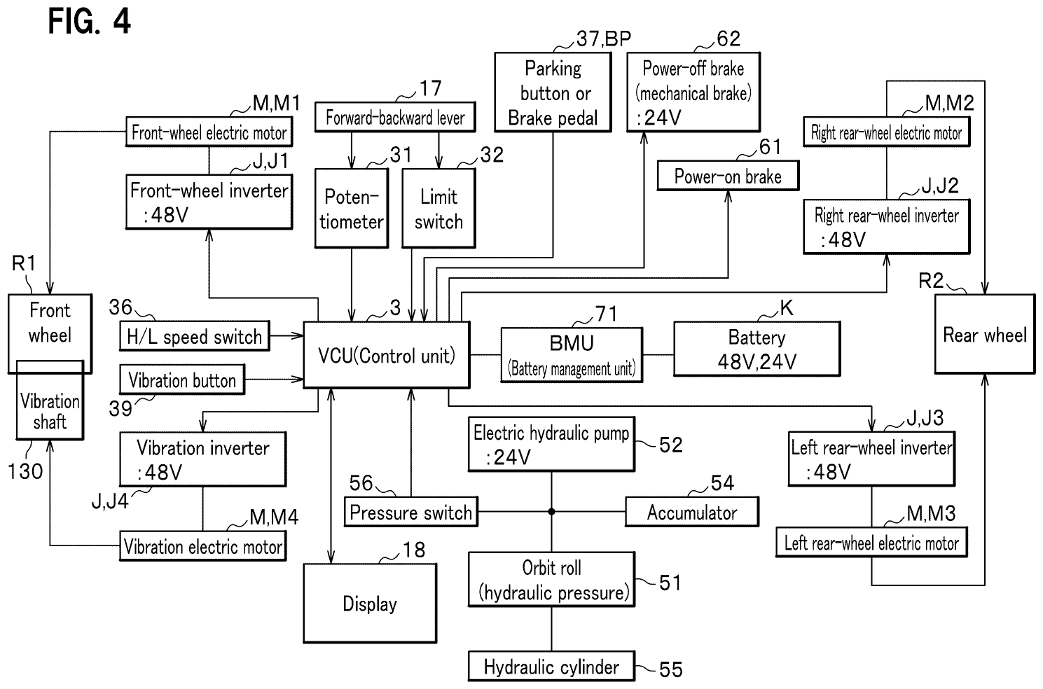

As shown in FIG. 4, the front-wheel electric motor M1 is an electric motor to drive the front wheel R1. The front-wheel electric motor M1 is driven according to a drive command value inputted from the control unit 3 to the front-wheel inverter J1. The right rear-wheel electric motor M2 is an electric motor to drive the rear wheel R2. The right rear-wheel electric motor M2 is driven according to a drive command value inputted from the control unit 3 to the right rear-wheel inverter J2.

The left rear-wheel electric motor M3 is an electric motor to drive the rear wheel R2. The left rear-wheel electric motor M3 is driven according to a drive command value inputted from the control unit 3 to the left rear-wheel inverter J3. Note that the front-wheel electric motor M1, the right rear-wheel electric motor M2, and the left rear-wheel electric motor M3 are collectively referred to as a “compaction-wheel electric motor.” Likewise, the front-wheel inverter J1, the right rear-wheel inverter J2, and the left rear-wheel inverter J3 are collectively referred to as a “compaction-wheel inverter.

As shown in FIG. 4, the vibration electric motor M4 is an electric motor to drive a vibration shaft 130. The vibration electric motor M4 is driven according to a drive command value inputted from the control unit 3 to the vibration inverter J4.

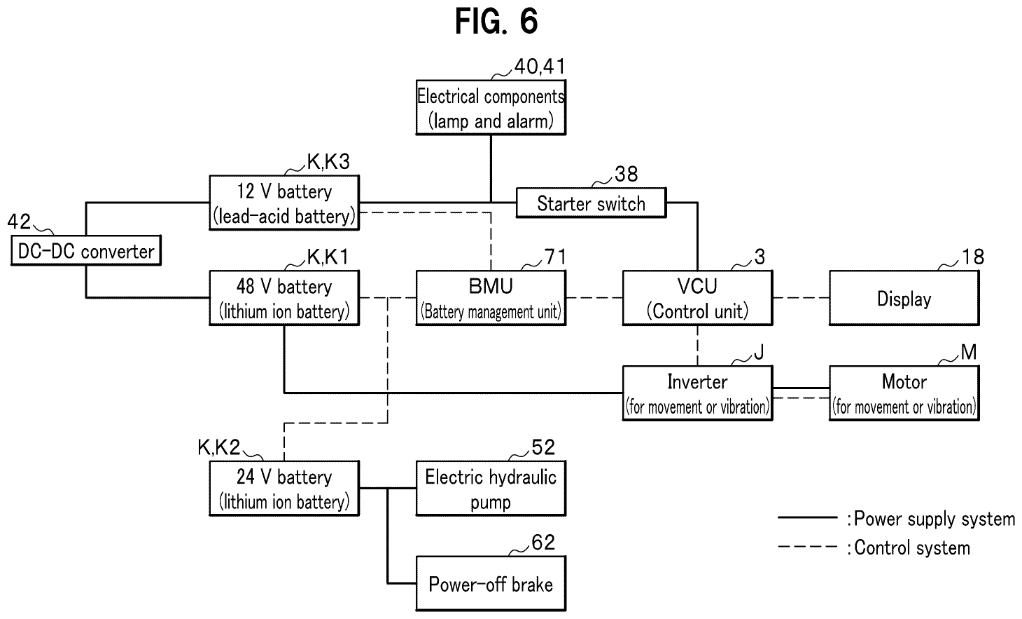

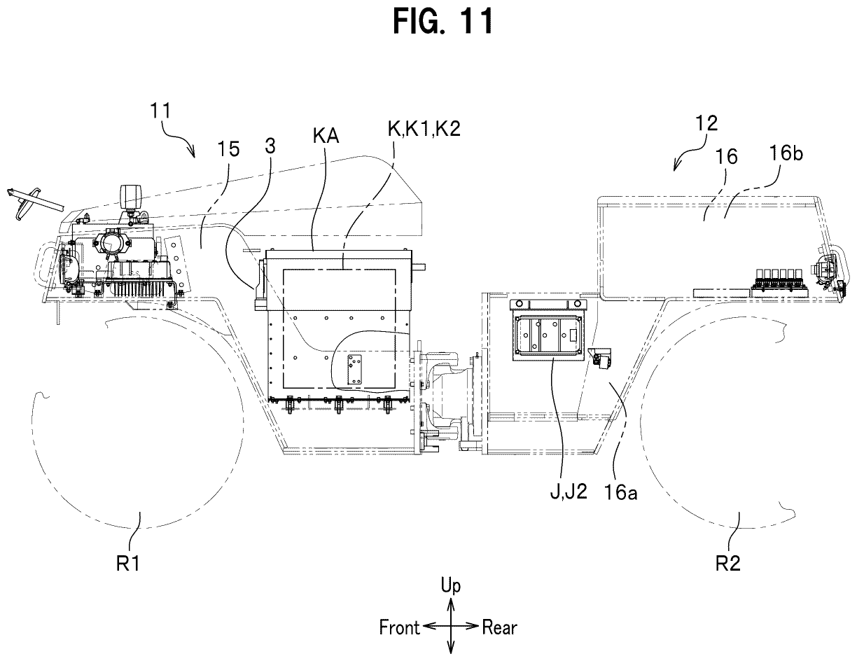

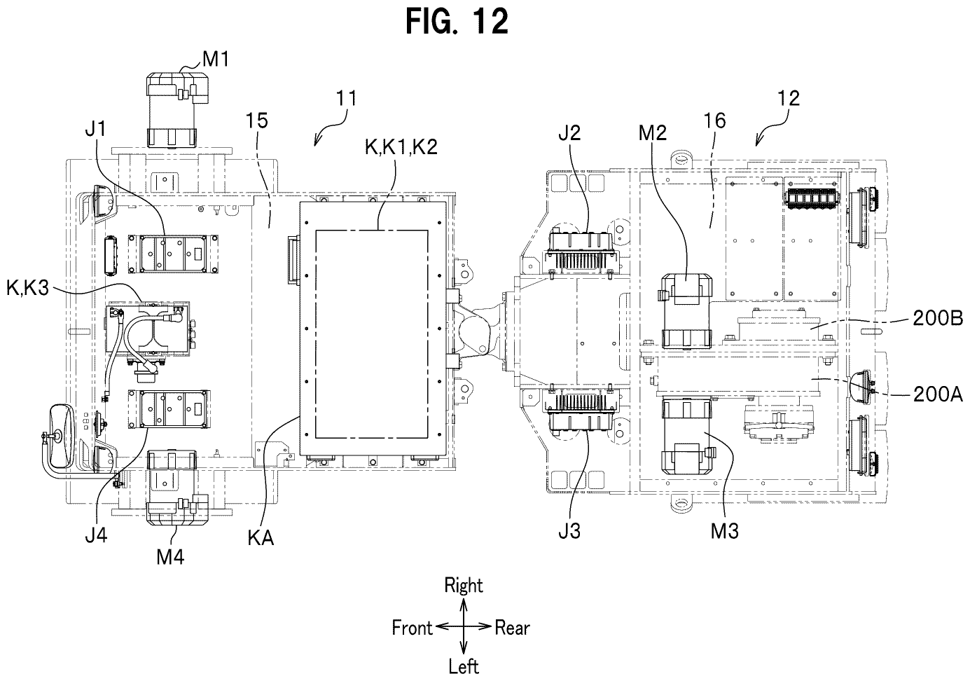

As shown in FIG. 6, the battery K is a component to supply power to various components such as the electric motor M and the inverter J. The battery K of the present embodiment includes the 48 V battery K1, 24 V battery K2, and 12 V battery K3, and is housed in a battery case KA (see FIG. 11) placed in the front space 15. The 48 V battery K1 and 24 V battery K2 are lithium ion secondary batteries. The 12 V battery K3 is a lead-acid battery. The battery K of the present embodiment is composed of three types of batteries with different voltages, but may be composed of any number of types, or may be composed of those with a common voltage level. A battery management unit 71 comprises a BMU (Battery Management Unit), for example. The control unit 3 is a controller to control the components. The control unit 3 comprises a VCU (Vehicle Control Unit), for example. The battery K, the battery management unit 71, and the control unit 3 can cooperate with each other through CAN communication used for transmitting battery information.

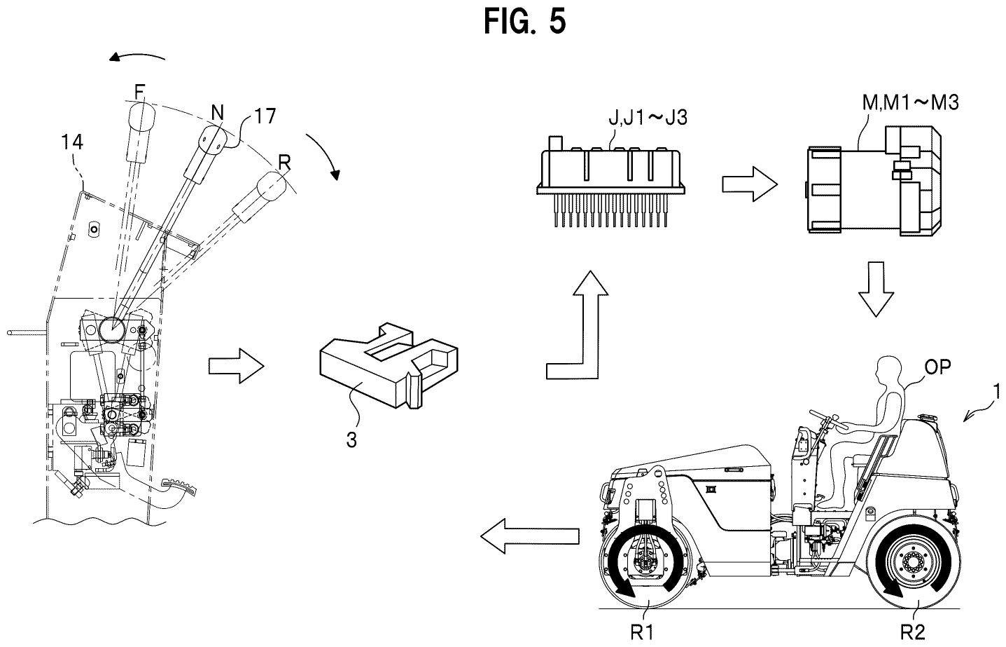

As shown in FIG. 5, the electric roller 1 uses the control unit 3 to output a drive command value to the inverter J (J1 to J3) according to a tilt angle of a forward-backward lever 17 by an operator OP. The electric motor M (M1 to M3) is rotated according to a drive command value inputted to the inverter J, to move the roller forward or backward. The electric roller 1 of the present embodiment is different from a conventional one which operates a hydraulic pump, using an internal combustion engine (engine or the like) by way of burning fuel such as gasoline, to drive one or more compaction wheels, on the point of having no internal combustion engine and using only the battery K as a power source for the compaction wheels. Additionally, the electric roller 1 of the present embodiment is different from a conventional one which controls acceleration and deceleration of the running speed thereof with hydraulic control, on the point of executing control with a drive command value outputted from the control unit 3 to the inverter J.

### <Moving System>

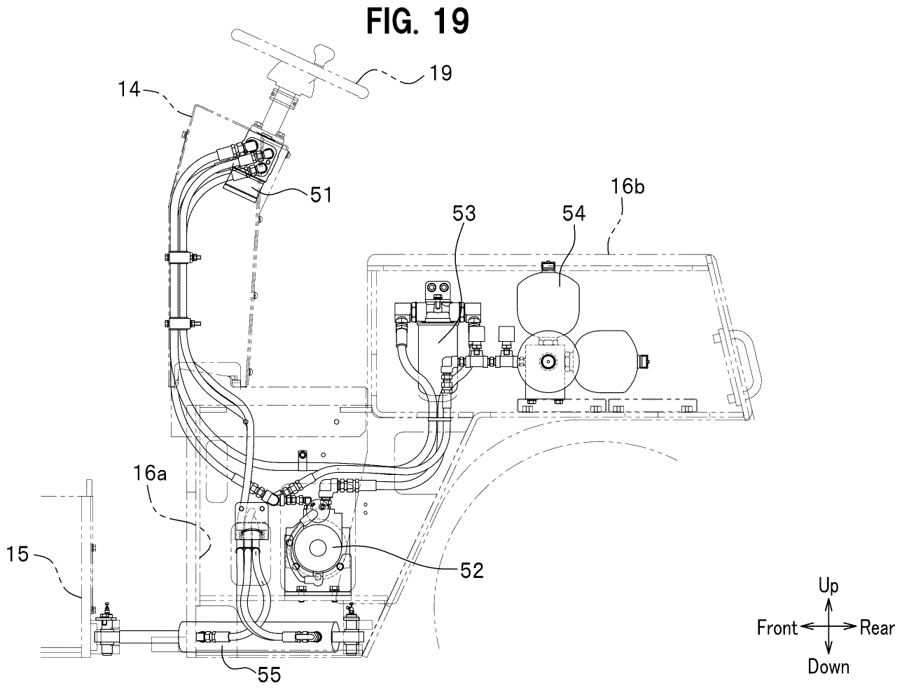

Next, a description is given in detail of a moving system. As shown in FIGS. 1 and 2, the driver's seat 13 is where the operator OP sits, and faces the dashboard 14. The dashboard 14 in front of the driver's seat 13 has a box-like form and is provided with a brake pedal BP projecting rearward and a display 18 on a top surface thereof. A steering wheel 19 is a device used for determining a moving direction of the vehicle, and is provided in the top surface of the dashboard 14. The steering wheel 19 is connected to an orbit roll (registered trademark and this applies to the same component hereinbelow; see FIGS. 4 and 19) 51 provided inside the dashboard 14.

As shown in FIG. 1, the brake pedal BP is provided at a lower portion on a rear side of the dashboard 14, and is configured to set off braking when the operator OP depresses the pedal. The forward-backward levers 17 are provided on both sides of the dashboard 14, and can be tilted to a neutral position, a forward position, and a reverse position. The forward-backward lever 17 may be provided only on one side of the dashboard 14.

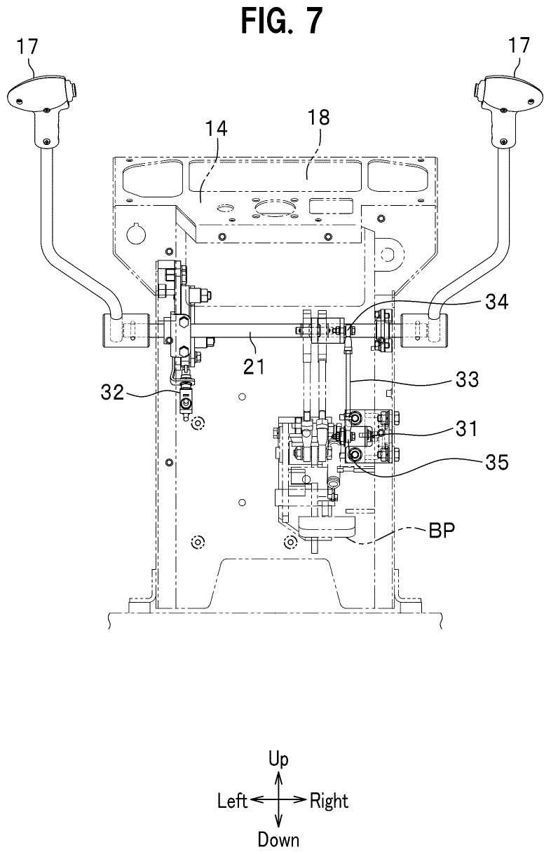

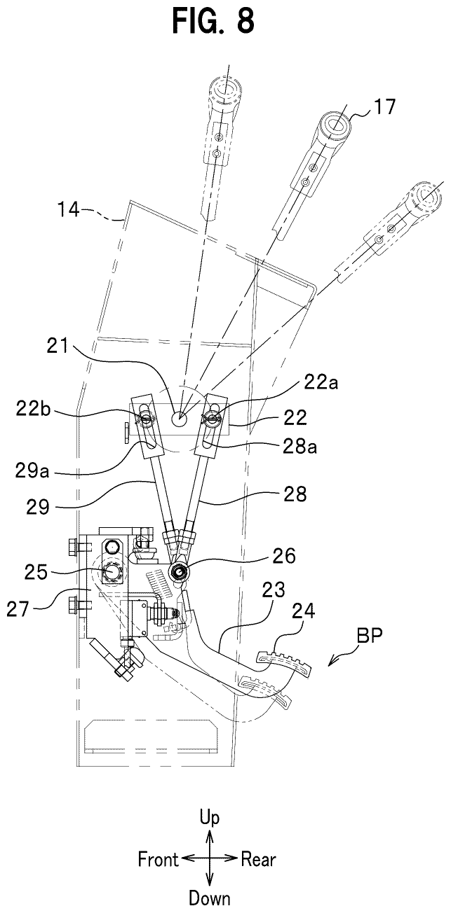

The forward-backward levers 17 are connected to both ends of a shaft 21, as shown in FIG. 7. The shaft 21 is arranged inside the dashboard 14 so as to run along a width direction of the vehicle. As shown in FIG. 8, the shaft 21 is provided with a plate-like base plate 22 to be pivoted in synchronization with the shaft 21 and fixed perpendicularly to the shaft 21.

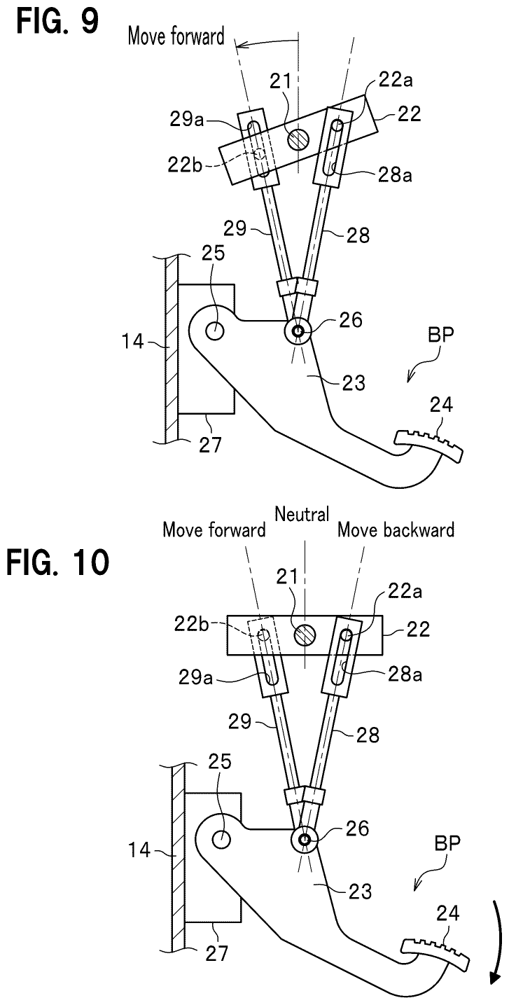

The brake pedal BP is configured to interlock with the shaft 21, as shown in FIG. 9. The base plate 22 is formed with a first pin 22a and a second pin 22b each protruding in the width direction of the vehicle. The first pin 22a and second pin 22b are provided at substantially equal distances from the shaft 21. The brake pedal BP includes a body plate 23, a pedal portion 24, a pivot fulcrum 25, and a connection fulcrum 26.

The body plate 23 is a plate-like member including the pedal portion 24 at a rear thereof. A front end of the body plate 23 is pivotably secured via a bracket 27 fixed to a front wall of the dashboard 14. The pivot fulcrum 25 is a pivot point of the brake pedal BP. The connection fulcrum 26 is formed at an upper portion of the body plate 23.

The connection fulcrum 26 is connected to the base plate 22 via a first brake pedal rod 28 and a second brake pedal rod 29. The first brake pedal rod 28 and second brake pedal rod 29 are rod-like members. The first brake pedal rod 28 and second brake pedal rod 29 are connected at lower ends thereof to the connection fulcrum 26 by pin connection.

The first brake pedal rod 28 is formed at an upper end thereof with an elongated hole 28a into which the first pin 22a is loosely fitted. The second brake pedal rod 29 is formed at an upper end thereof with an elongated hole 29a into which the second pin 22b is loosely fitted. The first brake pedal rod 28 and second brake pedal rod 29 jointly form a V-shape, when laterally viewed.

The base plate 22 is made approximately horizontal at an initial position (the forward-backward lever 17 is in the neutral position). Here, the first pin 22a and second pin 22b stay slightly higher than the respective centers in a height direction of the elongated holes 28a and 29a.

FIG. 9 is an operational diagram around the base plate 22 when the forward-backward lever 17 is tilted the most in the forward direction. When the forward-backward lever 17 is tilted forward, the shaft 21 and base plate 22 are accordingly pivoted counterclockwise about the shaft 21, as shown in FIG. 9. At this time, the first pin 22a is at an upper end in the elongated hole 28a of the first brake pedal rod 28. On the other hand, the second pin 22b stays slightly lower than the center in the height direction of the elongated hole 29a of the second brake pedal rod 29. Even with the forward-backward lever 17 being tilted forward, the position of the brake pedal BP remains unchanged because the first pin 22a and second pin 22b move in the elongated holes 28a and 29a, respectively.

Note that when the forward-backward lever 17 is tilted backward to move the vehicle backward, the base plate 22 is pivoted clockwise in synchronization with the shaft 21, although not specifically shown in the drawings. Again, even with the forward-backward lever 17 being tilted backward, the position of the brake pedal BP remains unchanged because the first pin 22a and second pin 22b respectively move in the elongated holes 28a, 29a, as in the case of moving the vehicle forward.

FIG. 10 is an operational diagram around the base plate 22 when the brake pedal BP is depressed. When the operator OP depresses the brake pedal BP, the brake pedal BP is pivoted downward about the pivot fulcrum 25, as shown in FIG. 10. Accordingly, the first brake pedal rod 28 and second brake pedal rod 29 are pulled downward, to have the first pin 22a and second pin 22b staying at the upper ends in the elongated holes 28a and 29a, respectively, and the base plate 22 pivoted by a predetermined angle to make the base plate 22 approximately horizontal. In synchronization with these, the shaft 21 and forward-backward lever 17 are also pivoted to neutral positions, to allow the brake to be activated to stop the vehicle.

As described above, the operator OP returning the forward-backward lever 17 to the neutral position or depressing the brake pedal BP causes the forward-backward lever 17 to be at the neutral position, to allow the vehicle to be stopped. The brake system is described in detail below.

As shown in FIGS. 4 and 7, the dashboard 14 is provided therein with a potentiometer 31. The potentiometer 31 is a device to detect a tilt angle of the forward-backward lever 17. The shaft 21 is provided with a connecting plate 34 extending in a direction perpendicular to an axial direction thereof. The potentiometer 31 has a connecting plate 35 connected thereto and pivoted in synchronization with the connecting plate 34. In addition, the connecting plates 34 and 35 are connected to each other by a connecting rod 33. A link mechanism of the connecting plates 34, 35 and connecting rod 33 allows the potentiometer 31 to detect a tilt angle when the forward-backward lever 17 is tilted. Detection results by the potentiometer 31 are outputted to the control unit 3.

Further, the dashboard 14 is provided therein, in vicinity to the shaft 21, with a limit switch (neutral sensor) 32, as shown in FIG. 7. The limit switch 32 is a device to detect the neutral position of the forward-backward lever 17. Detection results of the limit switch 32 are outputted to the control unit 3.

Still further, the display 18 on the top surface of the dashboard 14 displays various vehicle information kept in the control unit 3, such as a speedometer, remaining life of the battery K, mileage, an hour meter, and alert information. The display 18 may display touch operation panel. Additionally and/or alternatively, the display 18 may display information related to compaction, such as compaction status of the construction site, map information of the compaction area, and location information.

Still further, the dashboard 14 is provided on the top surface thereof with a H/L speed switch 36, a parking button 37, a vibration button 39, a lamp button, an alarm button, and the like, as shown in FIGS. 4 and 6.

The H/L speed switch 36 is a switch to select a high speed moving mode or a low speed moving mode. When the forward-backward lever 17 is tilted the most (full throttle), the high speed moving mode is set to 10 km/h and the low speed moving mode is set to 5 km/h, for example. These speeds can be set as appropriate.

The parking button 37 is a button to select setting or releasing a parking brake. The vibration button 39 is a button to select setting ON or OFF vibration of the front wheel R1. Optionally, a button may be provided that is linked to the vibration button 39 and used to control intensity of vibration (rotation speed). The lamp button is a button to select setting ON or OFF hazard lamps which flash, for example, when the vehicle is stopped. The alarm button is a button to select setting ON or OFF a back buzzer, for example, when the vehicle backs up. The display 18 may display ON or OFF status of these function switches (buttons).

As shown in FIG. 4, the inverter J includes the front-wheel inverter J1, right rear-wheel inverter J2, left rear-wheel inverter J3, and vibration inverter J4. The inverter J is a device to control a frequency, based on the drive command value outputted from the control unit 3, to change rotation speed of the electric motor M.

As shown in FIG. 4, the electric motor M includes the front-wheel electric motor M1, right rear-wheel electric motor M2, left rear-wheel electric motor M3, and vibration electric motor M4. Induction motors are used in the present embodiment, although a type of the electric motor M may be selected as appropriate.

<Structure of front-wheel R1 (vibration system)>

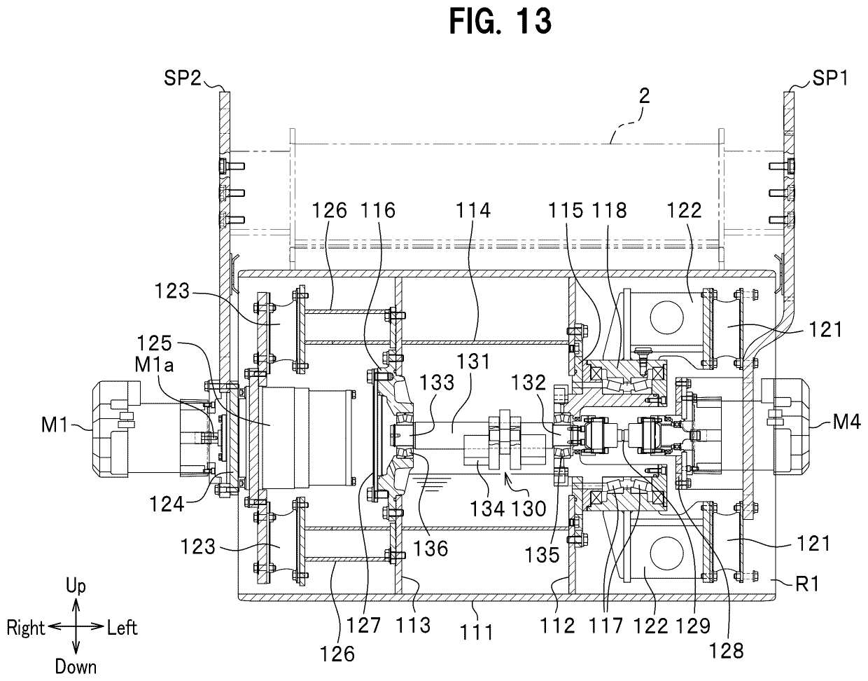

As shown in FIG. 13, the front wheel R1 is equipped with a roll 111, and has the front-wheel electric motor M1 and vibration electric motor M4 provided respectively at both ends in the width direction of the vehicle. The roll 111 has a hollow cylindrical shape, and is provided on an inner surface thereof with a first end plate 112 and a second end plate 113 spaced apart from each other. A vibrator case 114 in a hollow cylindrical shape is fixedly provided between the first end plate 112 and second end plate 113. The vibrator case 114 is filled therein with lubrication oil. The first end plate 112 has a first holder 115 attached thereto, and the second end plate 113 has a second holder 116 attached thereto. The first holder 115 is borne via a bearing 117 by a cylindrical housing 118. The housing 118 is attached via a vibration isolation rubber 121 and a support member 122 to the front-wheel side plate SP1 which is suspended from a left side surface of the vehicle frame 2 and has a lower end portion thereof extending inside the roll 111.

The second holder 116 is fixed to the second end plate 113. The front-wheel side plate SP2, which is suspended from a right side surface of the vehicle frame 2 and has a lower end portion thereof extending inside the roll 111, has the front-wheel electric motor M1 attached thereto via a motor mounting plate 124. The front-wheel electric motor M1 is provided at an output part M1a thereof with a reduction gear mechanism 125. The output part M1a is connected to the second end plate 113 via a vibration isolation rubber 123 and a support member 126. The second holder 116 has a cover 127 attached thereto to cover a right end thereof.

Accordingly, when the front-wheel electric motor M1 rotates, its rotational force is reduced by the reduction gear mechanism 125 and transmitted to the support member 126 and second end plate 113, to move and roll the roll 111, with the first holder 115 borne by the housing 118.

On the other end, the vibration electric motor M4 is attached, via a motor mounting plate 128 connected, to the front-wheel side plate SP1. The vibration electric motor M4 has an output shaft thereof coupled with the vibration shaft 130 by a joint member (e.g.; a constant-velocity joint) 129.

The vibration shaft 130 extends in the width direction of the vehicle, within the vibrator case 114, so as to be centered on an axis coaxial with the roll 111. The vibration shaft 130 includes a main body 131, support shafts 132 and 133 provided at both ends of the main body 131, and an eccentric weight 134. The main body 131 is a shaft-like portion, and is provided at both ends thereof with the support shafts 132 and 133 each having a smaller diameter than the main body 131. The support shaft 132 is borne by the first holder 115 via a bearing 135. Likewise, the support shaft 133 is borne by the second holder 116 via a bearing 136. The main body 131 is provided on an outer circumferential surface thereof with the eccentric weight 134.

Accordingly, when the vibration electric motor M4 rotates, its rotational force is transmitted to the vibration shaft 130 via the joint member 129, to rotate the vibration shaft 130 with respect to the first holder 115 and second holder 116. At this time, the roll 111 is vibrated because the vibration shaft 130 includes the eccentric weight 134.

When the operator OP operates the vibration button 39 (see FIG. 4), the control unit 3 outputs a vibration signal to the vibration inverter J4, and the vibration electric motor M4 is activated based on a drive command value from the vibration inverter J4. Note that a new operation button may be provided for a high vibration mode or a low vibration mode, for example. Rotating the vibration electric motor M4 at high speed increases vibration, while rotating the motor at low speed decreases vibration. Additionally and/or alternatively, the rotation speed of the vibration electric motor M4 may be freely controlled in accordance with operation by the operator OP, to adjust amplitude of vibration.

Note that the present embodiment has the vibration shaft 130 (vibration system) provided only in the front wheel R1, but may be additionally provided in the rear wheel R2, or only in the rear wheel R2.

### <Deceleration Mechanism>

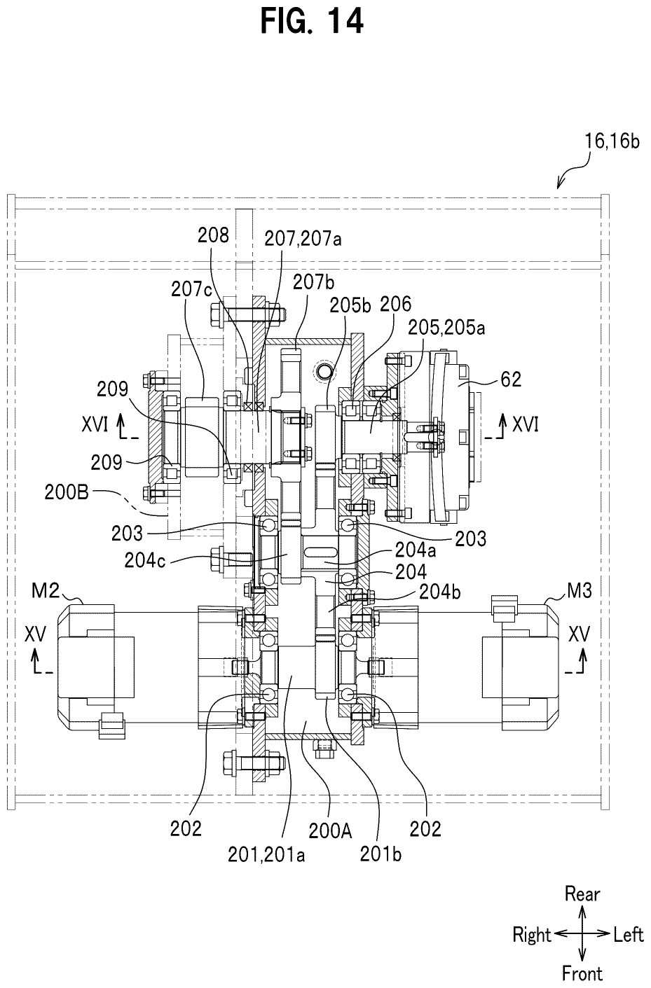

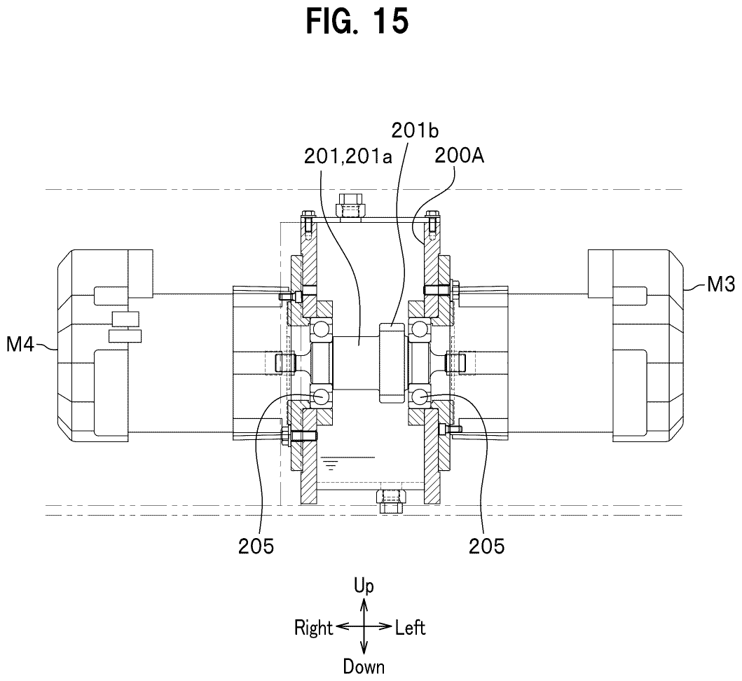

As shown in FIGS. 14 to 18, rotational forces of the right rear-wheel electric motor M2 and left rear-wheel electric motor M3 are transmitted to the rear wheel R2 via a deceleration mechanism. The deceleration mechanism includes a first gear box 200A and a second gear box 200B, and is provided partly in the second rear space 16b of the rear space 16 and partly around the rear wheel R2. As shown in FIG. 14, the right rear-wheel electric motor M2 and left rear-wheel electric motor M3 are provided such that output shafts thereof face each other and are parallel to the width direction of the vehicle.

The first gear box 200A includes a first gear 201, a second gear 204, a third gear 205, and a fourth gear 207. The first gear box 200A has a box-like form in a rectangular parallelepiped shape, and is placed in the second rear space 16b. The first gear 201, second gear 204, third gear 205, and fourth gear 207 all have rotating shafts arranged parallel to the width direction of the vehicle. The first gear box 200A is filled therein with lubrication oil.

The first gear 201 includes a shaft portion 201a, and a gear portion 201b set on the shaft portion 201a. The shaft portion 201a is connected, at both ends thereof, to the output shafts of the right rear-wheel electric motor M2 and left rear-wheel electric motor M3, and is borne by bearings 202 in the first gear box 200A.

The second gear 204 includes a shaft portion 204a, and a large-diameter gear 204b and a small-diameter gear 204c which are set on the shaft portion 204a. The shaft portion 204a is borne, at both ends thereof, by bearings 203 in the first gear box 200A. The large-diameter gear 204b is meshed with the gear portion 201b of the first gear 201 and a gear portion 205b of the third gear 205, respectively. The small-diameter gear 204c is meshed with a large-diameter gear 207b of the fourth gear 207.

The third gear 205 includes a shaft portion 205a, and the gear portion 205b set on the shaft portion 205a. The shaft portion 205a is borne by a bearing 206 in the first gear box 200A. The shaft portion 205a is connected, at a front end thereof, to a power-off brake (negative brake) 62. That is, the power-off brake 62 is connected to, on an outside of, the first gear box 200A via the shaft portion 205a.

The fourth gear 207 includes a shaft portion 207a, and the large-diameter gear 207b and a small-diameter gear 207c which are set on the shaft portion 207a. The shaft portion 207a connects the first gear box 200A with the second gear box 200B, and is borne by bearings 209 in the second gear box 200B. A seal member 208 is interposed between the first gear box 200A and an outer periphery of the shaft portion 207a. The large-diameter gear 207b is arranged in the first gear box 200A so as to mesh with the small-diameter gear 204c of the second gear 204. The small-diameter gear 207c is arranged in the second gear box 200B.

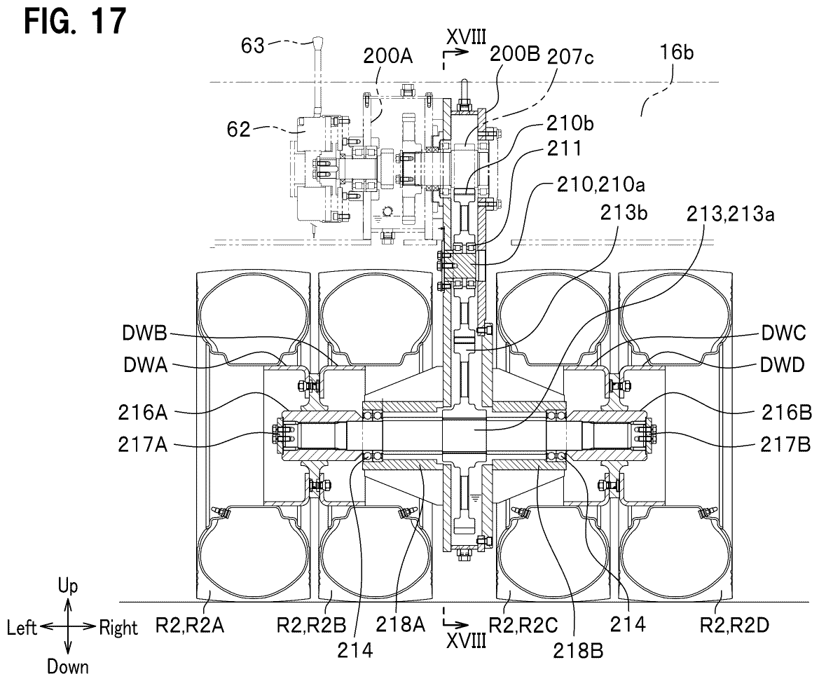

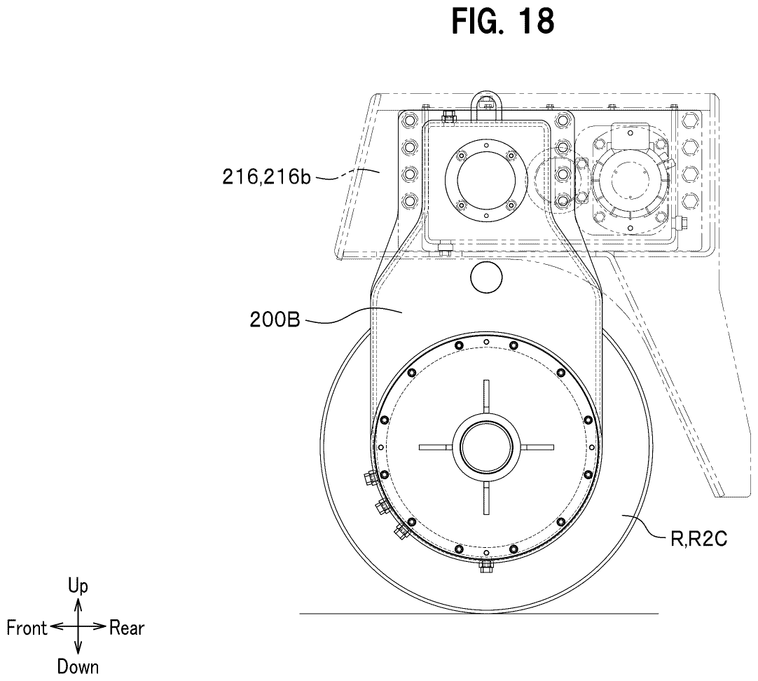

As shown in FIG. 17, the second gear box 200B is arranged side-by-side with the first gear box 200A, and has a vertically-elongated box-like form provided partly in the second rear space 16b and partly around the rear wheel R2. A fifth gear 210 includes a shaft portion 210a, and a gear portion 210b set on the shaft portion 210a. The shaft portion 210a is borne by a bearing 211 in the second gear box 200B. The gear portion 210b meshes with the small-diameter gear 207c of the fourth gear 207 and a gear portion 213b of a sixth gear 213.

The sixth gear 213 includes a shaft portion 213a and the gear portion 213b set on the shaft portion 213a. The shaft portion 213a is a shaft extending across the tires R2A to R2D of the rear wheel R2. The second gear box 200B is provided at a bottom thereof with holders 218A and 218B respectively extending left and right in the width direction of the vehicle and bearing the shaft portion 213a via bearings 214. A left end of the shaft portion 213a is fastened to a hub 216A via a fastening portion 217A. The hub 216A supports disc wheels DWA and DWB provided in the tires R2A and R2B, respectively.

Likewise, a right end of the shaft portion 213a is fastened to a hub 216B via a fastening portion 217B. The hub 216B supports disc wheels DWC and DWD provided in the tires R2C and R2D, respectively.

With the reduction mechanism configured as above, rotational forces of the right rear-wheel electric motor M2 and left rear-wheel electric motor M3 are transmitted to the shaft portion 213a via the first gear 201, second gear 204, fourth gear 207, fifth gear 210, and sixth gear 213, and are also transmitted to the rear wheel R2 via the hubs 216A and 216B.

### <Steering System>

Next, a description is given of a steering system. As shown in FIG. 19, the steering system includes an orbit roll 51, an electric hydraulic pump 52, a filter 53, an accumulator 54, hydraulic cylinders 55, and a pressure switch 56 (see FIG. 4). The steering system has these parts connected with piping to each other, to form a hydraulic circuit.

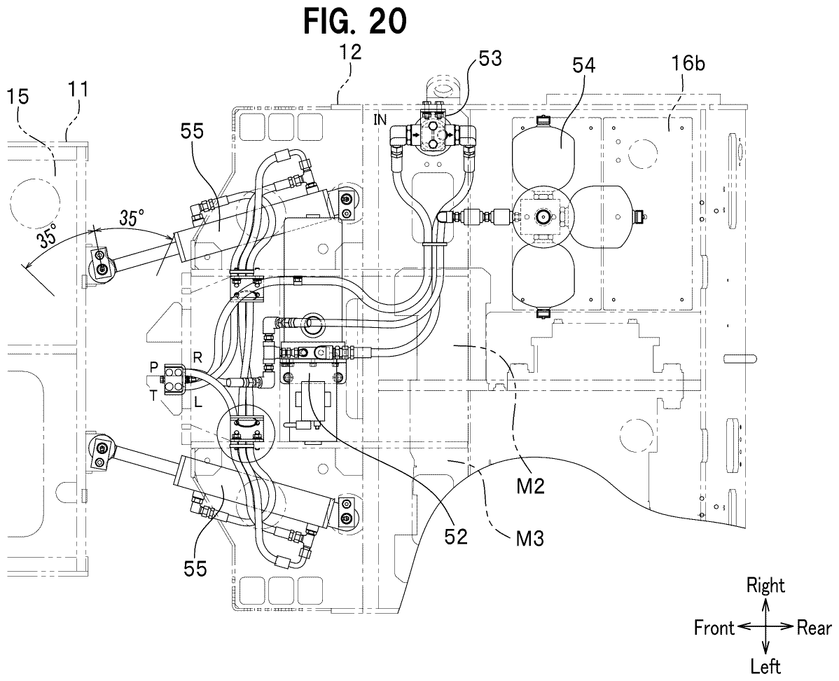

The orbit roll 51 is connected to the steering wheel 19 and provided inside the dashboard 14. The electric hydraulic pump 52 is electrically connected to the 24 V battery K2 and is placed in the first rear space 16a. The filter 53 is connected to a part of the piping and is a member to remove impurities, such as dust and iron, contained in the hydraulic oil. The accumulator 54 is connected to a part of the piping, and is a device to store and release fluid energy of hydraulic oil. The filter 53 and accumulator 54 are provided in the second rear space 16b. As shown in FIG. 20, the hydraulic cylinders 55 are cylinders to connect the front frame 11 with the rear frame 12, and provided in a pair on both sides in the width direction of the vehicle. The hydraulic cylinders 55 are extended and contracted to turn the vehicle in the right-left direction.

As shown in FIG. 4, the pressure switch 56 is used to check pressure in the hydraulic circuit and determine whether to start or stop the electric hydraulic pump 52. The control unit 3 receives a detection signal from the pressure switch 56 and starts the electric hydraulic pump 52 when the pressure in the hydraulic circuit falls below a predetermined value, and stops the electric hydraulic pump 52 when the pressure becomes equal to or greater than the predetermined value. The pressure switch 56 can also detect a pressure error in the hydraulic circuit.

The steering system includes the electric hydraulic pump 52, hydraulic cylinders 55 driven by pressure oil discharged from the electric hydraulic pump 52, and a steering valve (not shown) to control a flow direction and a flow rate of the pressure oil supplied from the electric hydraulic pump 52 to the hydraulic cylinders 55. The steering valve is switched according to a direction and amount of rotation of the steering wheel 19 to drive and control the hydraulic cylinders 55. The orbit roll 51 is the one to switch the steering valve according to the direction and amount of rotation of the steering wheel 19.

### <Brake System>

### <<1) Neutral Brake>>

The present embodiment provides brake systems 1) to 3) as described below. Note that types of brakes are not limited to these and may be more or less in number as appropriate. A neutral brake is a brake activated when the forward-backward lever 17 is shifted to the neutral position through operation by the operator OP, as shown in FIG. 4. When stopping, the vehicle is decelerated by regenerative motion and reverse braking of the compaction-wheel electric motors, and electrically stopped by a zero-rotation holding brake (power-on brake 61). The power-on brake 61 is a brake which is activated when energized and released when de-energized.

When the forward-backward lever 17 is at the neutral position, the limit switch 32 outputs a detection signal to the control unit 3. The control unit 3 outputs drive command values to the front-wheel inverter J1, right rear-wheel inverter J2, and left rear-wheel inverter J3, respectively, so as to cause the front-wheel electric motor M1, right rear-wheel electric motor M2, and left rear-wheel electric motor M3 to have zero rotations. In addition, the control unit 3 outputs a brake signal to the power-on brake 61. After a predetermined period of time since outputting the drive command value (to hold zero rotations) to the inverter J, the control unit 3 releases braking by the power-on brake 61, while the power-off brake 62 (see FIGS. 4 and 14) is activated through a relay for activation. The predetermined time can be set as appropriate. The power-off brake 62 is controlled through the relay for activation connected to the control unit 3.

### <<2) Foot Brake (Emergency Stop)>>

A foot brake is a brake activated by the brake pedal BP having been depressed, as shown in FIGS. 4 and 8. When the operator OP depresses the brake pedal BP, a foot brake signal is outputted to the control unit 3. Then, the control unit 3 cuts off power to the electric motor M. Additionally, depressing the brake pedal BP causes the base plate 22, which has been tilted by the mechanism in FIGS. 9 and 10, to return to a horizontal position, as described above. That is, the shaft 21 (and the forward-backward lever 17) is at the neutral position, to allow the above-described neutral brake to be activated.

### <<3) Parking Brake>>

A parking brake is a brake activated by the parking button 37 having been pushed down, as shown in FIG. 4. When the operator OP pushes down the parking button 37, a parking brake signal is outputted to the control unit 3. Then, the control unit 3 activates the power-off brake 62.

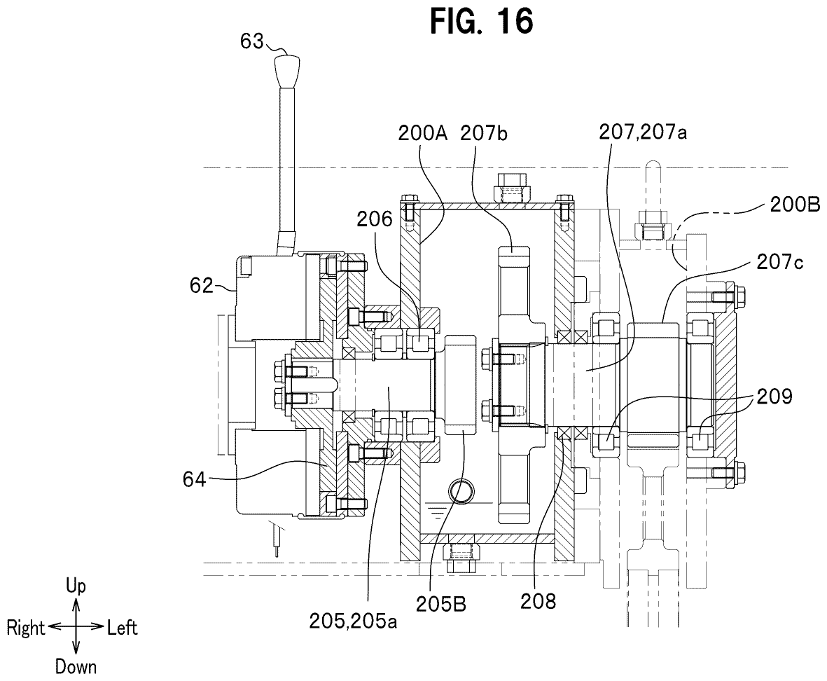

As shown in FIG. 16, the power-off brake 62 is a mechanical disc brake activated when not energized. The power-off brake 62 is electrically connected to the 24 V battery K2. When energized, the power-off brake 62 allows a rotor 64, which is rotated in synchronization with the shaft portion 205a of the third gear 205, to be rotated. This allows the third gear 205 to be rotated too, to move the vehicle. In contrast, when not energized, the brake is activated, with the rotor 64 held in-between to prevent the shaft portion 205a from being rotated. Note that the power-off brake 62 is provided with a release lever 63. The power-off brake 62 is released by the operator OP or a worker operating the release lever 63.

### <Electrical System>

As shown in FIG. 6, the battery K of the present embodiment includes the 48 V battery K1, 24 V battery K2, and 12 V battery K3. The 48 V battery K1 and 24 V battery K2 are lithium ion batteries. The battery management unit (BMU) 71 is a device to monitor and control the battery (lithium ion secondary battery) K by measuring voltage values, current values, temperatures, and the like of battery cells. The battery management unit 71 also has a function to display measured data, a function to balance voltages between cells with constant values, and a function to detect overcharge and overdischarge. The battery management unit 71 can communicate battery information with the control unit 3 via CAN communication.

The 12 V battery K3 is a lead-acid battery. The 12 V battery K3 is electrically connected to a starter switch 38 to start the electric roller 1. Additionally, the 12 V battery K3 is electrically connected to electrical components including a lamp (e.g.; a hazard lamp) 40 and an alarm (e.g., a back buzzer or an alert buzzer) 41. The 12 V battery K3 can start (or restart) the electric roller 1 and supply power to various electrical components, for example, even when the control unit 3 has a system failure.

The 48 V battery K1 is electrically connected to the inverter J and electric motor M. A DC/DC converter 42 is interposed between the 48 V battery K1 and 12 V battery K3. The DC/DC converter 42 is a device to step down voltage in order to supply power from the 48 V battery K1 to the 12 V battery K3. The 24 V battery K2 is electrically connected to the electric hydraulic pump 52 and power-off brake 62.

The control unit (VCU) 3 is a device to judge a vehicle condition, which changes while the vehicle is moving, and control components in order to maintain an optimum condition. The control unit 3 controls the components such as the electric motor M, inverter J, and battery K, which influence each other, with influence on other components taken into account.

The control unit 3 includes a processing unit (CPU: Central Processing Unit), a storage unit, and a communication unit. The control unit 3 may be placed anywhere, but that of the present embodiment is attached to a front of the battery case KA (see FIG. 11) of the battery K. The processing unit is a unit to retrieve a program stored in the storage unit and make the program function as a functional unit. The storage unit includes a RAM (Random Access Memory), a ROM (Read Only Memory), and an HDD (Hard Disk Drive). The storage unit stores various programs, and drive command values, such as those for the inverter J with respect to tilt angles of the potentiometer 31, in a form of a drive command value file. The communication unit uses CAN communication, for example, to communicate with the components.

In addition, the control unit 3 may interact with GNSS (Global Navigation Satellite System), to obtain and utilize driving records, position information, driving conditions, and the like. Further, the control unit 3 may interact with a compaction management device including a sensor for obtaining information on a compacted road surface, to obtain and utilize compaction information in real time. Still further, the control unit 3 may interact with an autonomous driving device, to drive the host vehicle autonomously through remote control. Still further, the control unit 3 may transmit operation information of the vehicle (such as driving time, abnormality information, and battery condition) to a technical center, a leasing company, or the like, so that the information is accumulated and managed.

### <Operation and Advantageous Effects>

When the forward-backward lever 17 is tilted forward by the operator OP, the vehicle moves forward, while when the lever 17 is tilted backward, the vehicle moves backward. When the forward-backward lever 17 is tilted, the potentiometer 31 outputs the tilt angle to the control unit 3. The control unit 3 outputs drive command values to the front-wheel inverter J1, right rear-wheel inverter J2, and left rear-wheel inverter J3, to drive the compaction-wheel electric motors based on the drive command values. When the tilt angle of the forward-backward lever 17 is increased, the vehicle moves faster, while when the tilt angle is decreased, the vehicle moves slower. When the forward-backward lever 17 is returned to the neutral position, the above-described neutral brake is activated to stop the electric roller 1.

When the vibration button 39 is operated by the operator OP, a vibration signal is outputted to the control unit 3. Then, the control unit 3 transmits a vibration command value to the vibration inverter J4, to drive the vibration electric motor M4 based on the vibration command value. This causes the vibration shaft 130 to be rotated to vibrate the front wheel R1.

The above-described electric roller 1 according to the present embodiment substantially eliminates fuel consumption and greenhouse gas emissions through electrification. Electrification also reduces noise and substantially eliminates greenhouse gas emissions, to allow for easing a burden on the operator OP and improving work environment. Additionally, there is no need to replace hydraulic oil because no hydraulic pump or hydraulic circuit is used to move the vehicle, unlike conventional models, to have superior maintainability.

Further, the present embodiment includes two or more compaction-wheel electric motors (front-wheel electric motor M1, right rear-wheel electric motor M2, and left rear-wheel electric motor M3). Having two or more compaction-wheel electric motors helps increasing a prime torque, while preventing the compaction-wheel electric motor from increasing in size, although a single compaction-wheel electric motor may do the job. This allows for stopping and starting the vehicle on a slope.

Still further, the present embodiment includes the potentiometer 31, to allow for fine speed control based on a degree of inclination of the forward-backward lever 17. Additionally, the present embodiment includes the limit switch 32, to allow for reliably detect the neutral position. The potentiometer 31 alone can detect the lever being in neutral, but if an input from the potentiometer 31 has an error, the vehicle may start off even when the forward-backward lever 17 is in neutral. However, the present embodiment with the limit switch 32 reliably detects the neutral position.

Still further, the present embodiment is equipped with electrical components including the lamp 40 and alarm 41, and provided with two or more members of the battery K having different voltages from each other and electrically connected to the compaction-wheel electric motors and electrical components. This allows for supplying power in accordance with operating voltages of the components. Additionally, the 48 V battery K1 and 24 V battery K2 are lithium ion batteries (storage batteries) and thus are used repeatedly through recharging.

Still further, the battery K of the present embodiment is placed in the front space 15 of the vehicle frame 2, to allow for reducing the vehicle in size through effective use of a loading space. In other words, the battery K can be placed in a space for an engine of a conventional model. Additionally, housing the battery K in the battery case KA allows for protecting the battery K. Note that only the rear space 16 may be used to place the battery K, or both the front space 15 and rear space 16 may be used.

Still further, the present embodiment has the electrical components, including the lamp 40 and alarm 41, electrically connected to the 12 V battery K3 comprising a lead-acid battery. This allows the electrical components, including the lamp 40, to work even when the control unit 3 has a system failure. Accordingly, an alert or the like can be raised to those around, even with a system failure, to solicit a smooth reboot and restart of the system.

Still further, the display 18 of the present embodiment, provided on the dashboard 14, is capable of displaying a speedometer, along with vehicle information kept in the control unit 3. This allows the operator OP to know vehicle information kept in the control unit 3, such as whether the roller is moving forward or backward, presence or absence of vibration, amount of battery charge, time, and total moving distance, in addition to the speed.

Still further, the present embodiment uses the vibration inverter J4 and vibration electric motor M4 to activate the vibration shaft 130, although a mechanism to vibrate the compaction wheels may be provided as required. This facilitates vibration control of the vibration shaft 130, and substantially eliminates fuel consumption and greenhouse gas emissions through electrification of the vibration shaft 130. Electrification of the vibration shaft 130 also reduces noise and substantially eliminates greenhouse gas emissions, to allow for easing a burden on the operator OP and improving work environment. Additionally, there is no need to replace hydraulic oil because no hydraulic pump or hydraulic circuit is used for vibration, unlike conventional models, to have superior maintainability.

Still further, the vibration electric motor M4 with the present embodiment is provided above a suspension (above, or closer to the vehicle frame 2 than, the vibration isolation rubber 121), to allow for reducing vibration acting on the vibration electric motor M4. Additionally, the vibration electric motor M4 has the output shaft thereof coupled with the vibration shaft 130 by the constant-velocity joint, to allow for transmitting a driving force of the vibration electric motor M4 to the vibration shaft 130, even when one shaft works at an angle to the other shaft.

Still further, the steering system of the present embodiment uses the electric hydraulic pump 52, to substantially eliminate fuel consumption and greenhouse gas emissions through electrification. Electrification also reduces noise and substantially eliminates greenhouse gas emissions, to allow for easing a burden on the operator OP and improving work environment. Additionally, the present embodiment uses the electric hydraulic pump 52 to drive the hydraulic cylinder 55, to allow for minimizing a change in a mechanism for steering through electrification.

Still further, the accumulator 54 is used in the present embodiment to accumulate pressure, to prevent seizure due to continuous operation of the electric hydraulic pump 52 and reduce energy consumption.

Still further, the electric hydraulic pump 52, piping, and accumulator 54 of the present embodiment are placed in the rear space 16 of the vehicle frame 2, to allow for effectively utilizing the rear space 16 and reducing the number of pipes to bridge between the front space 15 and the rear space 16, and the like.

Still further, the hydraulic cylinders 55 of the present embodiment is provided on both the right and left sides of the vehicle frame 2, to allow for reducing or eliminating difference in amount of oil discharged in the right-left direction when the vehicle turns, to stabilize vehicle behavior when the vehicle turns. Note that the vehicle frame 2 may be provided with the single hydraulic cylinder 55. This leads to simplifying the structure and reducing parts in number.

Still further, when the forward-backward lever 17 is in neutral, the control unit 3 of the present embodiment outputs a zero-rotation signal to the compaction-wheel inverter (front-wheel inverter J1, right rear-inverter J2, left rear-wheel inverter J3) and activates the power-on brake 61. This facilitates configuring the brake system, and electrifying the brake system substantially eliminates fuel consumption and greenhouse gas emissions. Electrification also reduces noise and substantially eliminates greenhouse gas emissions, to allow for easing a burden on the operator OP and improving work environment. Additionally, there is no need to replace hydraulic oil because no hydraulic circuit is used in the brake system, unlike conventional models, to have superior maintainability.

Still further, the control unit 3 of the present embodiment activates the power-off brake 62, which applies braking mechanically, after a predetermined period of time has elapsed since activating the power-on brake 61. Once activated, the power-on brake 61 continuously consumes power while the vehicle remains stopped, but the control unit 3 of the present embodiment switches the power-on brake 61 to the power-off brake 62, after a predetermined period of time has elapsed, and releases the power-on brake 61, to allow for reducing power consumption.

Still further, when the operator OP has depressed the brake pedal BP or has operated a button (parking button 37) at the dashboard 14 or driver's seat 13, the control unit 3 activates the power-off brake 62, which applies braking mechanically, through the relay for activation. This allows the vehicle to be stopped in emergency situations.

Still further, the release lever 63 is provided around the driver's seat 13 for releasing the power-off brake 62, to facilitate releasing the power-off brake 62.

### Second Embodiment

### <Excessive Rotation Prevention Mechanism for Compaction-Wheel Electric Motor>

Next, a description is given of a second embodiment of the present invention. The electric roller 1 according to the second embodiment is different from the first embodiment on the point that the former includes an excessive rotation prevention mechanism to prevent the front-wheel electric motor M1 from excessively rotating, right rear-electric motor M2, and left rear-wheel electric motor M3 (collectively the compaction-wheel electric motor). The second embodiment is described, focusing on differences from the first embodiment. Note that the drive command values and times described below are merely examples, and these values can be set as appropriate.

### <Issues>

As described above, the electric roller 1 is controlled such that a degree of inclination of the forward-backward lever 17 is inputted to the control unit 3, and the control unit 3 outputs a drive command value for acceleration, deceleration, or stop to the inverter J. The inverter J having received the drive command value from the control unit 3 outputs a drive command value of rotation speed to the compaction-wheel electric motor for acceleration or deceleration according to the input amount to the forward-backward lever 17, to control moving of the vehicle.

However, the above-described embodiments has a problem of a vehicle behavior being unstable while the vehicle is accelerated, decelerated, or stopped. For example, when the forward-backward lever 17 is operated at full throttle in the forward direction for accelerating the vehicle, the drive command value inputted to the inverter J sharply increases from zero rotations to the aimed drive command value. At this time, power of the compaction-wheel electric motor is too small to control an inertial force generated during acceleration. As a result, the compaction-wheel electric motor is excessively rotated with respect to the aimed drive command value by an amount of the inertia force beyond control.

Likewise, when the vehicle is decelerated or stopped, the compaction-wheel electric motor is controlled to apply regenerative motion and reverse braking for deceleration. When the forward-backward lever 17 is returned from a full throttle mode to the neutral position for decelerating or stopping the vehicle, the drive command value outputted to the compaction-wheel electric motor sharply decreases to zero rotations. A braking torque generated at this time is beyond control due to insufficient power of the compaction-wheel electric motor, to have a swing back motion when the vehicle is being stopped, by an amount of the braking torque beyond control.

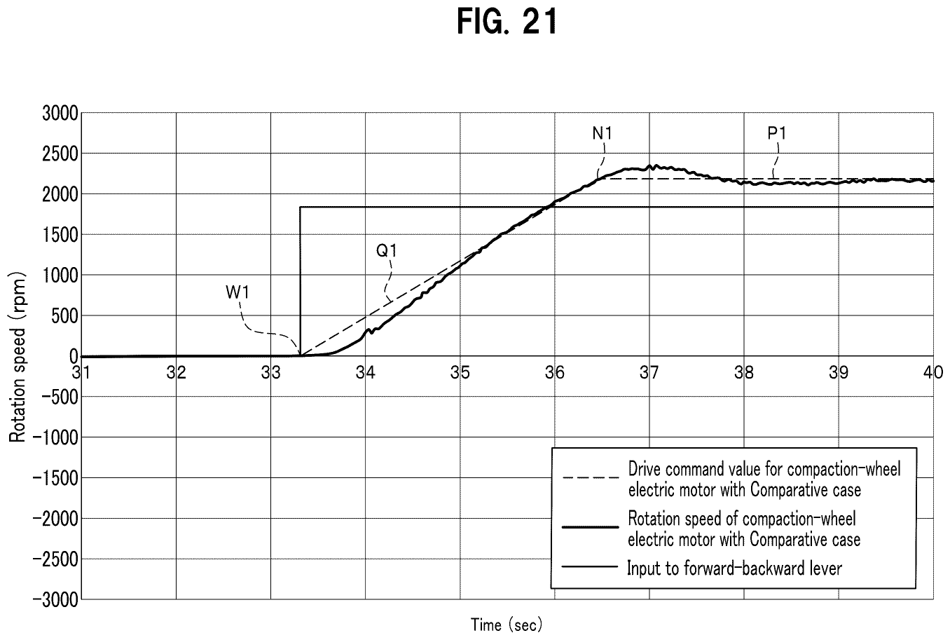

A description is given in more detail of these issues. FIG. 21 shows a chart indicating a relationship between time and rotation speed at a start time with a comparative case. As illustrated in FIG. 21, a thin line indicates an input to the forward-backward lever 17. For example, The forward-backward lever 17 is in the most tilted mode (full throttle mode) in the forward or backward direction.

A dotted line indicates a drive command value for the compaction-wheel electric motor with the comparative case. In other words, the line indicates a drive command value outputted from the control unit 3 to the compaction-wheel inverter. An aimed drive command value P1 with the comparative case in FIG. 21 is approximately 2200 rpm. A time when an input is made to the forward-backward lever 17 is referred to as an “acceleration command start point W1,” a time when a drive command value for the compaction-wheel electric motor reaches the aimed drive command value P1 (calculated time) is referred to as an “aimed acceleration rotation speed N1,” and a line connecting the acceleration command start point W1 with the aimed acceleration rotation speed N1 is referred to as a “first stage acceleration Q1.” The rotation speed with the comparative case is set to reach 2200 rpm from 0 rpm in about 3.0 seconds, for example.

A thick line indicates the rotation speed (actual rotation speed) of the compaction-wheel electric motor with the comparative case. The rotation speed of the compaction-wheel electric motor with the comparative case is lower, immediately after the acceleration command start point W1, than the first stage acceleration Q1, as the drive command value. However, the rotation speed of the compaction-wheel electric motor is higher, for a predetermined period of time after reaching the aimed acceleration rotation speed N1, than the aimed drive command value P1, because of an inertial force generated during acceleration being beyond control. The rotation speed of the compaction-wheel electric motor becomes slightly lower afterward than the aimed drive command value P1 and then comes to the aimed drive command value P1. That is, the compaction-wheel electric motor with the comparative case is excessively rotated for a predetermined period of time after reaching the aimed acceleration rotation speed N1, resulting in unstable vehicle behavior.

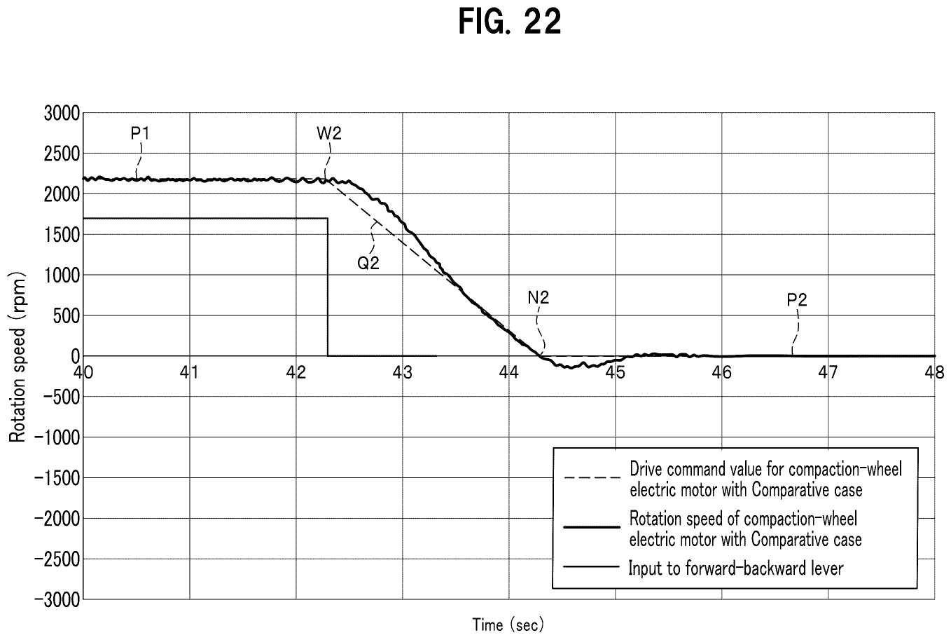

FIG. 22 shows a chart indicating the relationship between time and rotation speed at a stop time with the comparative case. As shown in FIG. 22, an aimed drive command value P2 for stopping is 0 rpm (zero rotations). A time when the forward-backward lever 17 is returned from the full throttle mode to the neutral position is referred to as a “deceleration command start point W2,” a time when the drive command value for the compaction-wheel electric motor reaches the aimed drive command value P2 (calculated time) is referred to as an “aimed deceleration rotation speed N2,” and a straight line connecting the deceleration command start point W2 with the aimed deceleration rotation speed N2 is referred to as a “first stage deceleration Q2.” The rotation speed with the comparative case is set to reach 0 rpm from 2200 rpm in about 2.0 seconds, for example.

The rotation speed of the compaction-wheel electric motor with the comparative case is larger, immediately after the deceleration command start point W2, than the drive command value. However, the rotation speed of the compaction-wheel electric motor is lower, for a predetermined period of time after reaching the aimed deceleration rotation speed N2, than the aimed drive command value P2, because of a generated braking torque being beyond control due to insufficient power of the compaction-wheel electric motor. The rotation speed of the compaction-wheel electric motor then comes to the aimed drive command value P2. That is, the compaction-wheel electric motor with the comparative case is excessively rotated for a predetermined period of time after reaching the aimed deceleration rotation speed N2, resulting in unstable vehicle behavior (swing back motion when the vehicle is being stopped).

### <Excessive Rotation Prevention Mechanism for Compaction-Wheel Electric Motor: at Start Time>

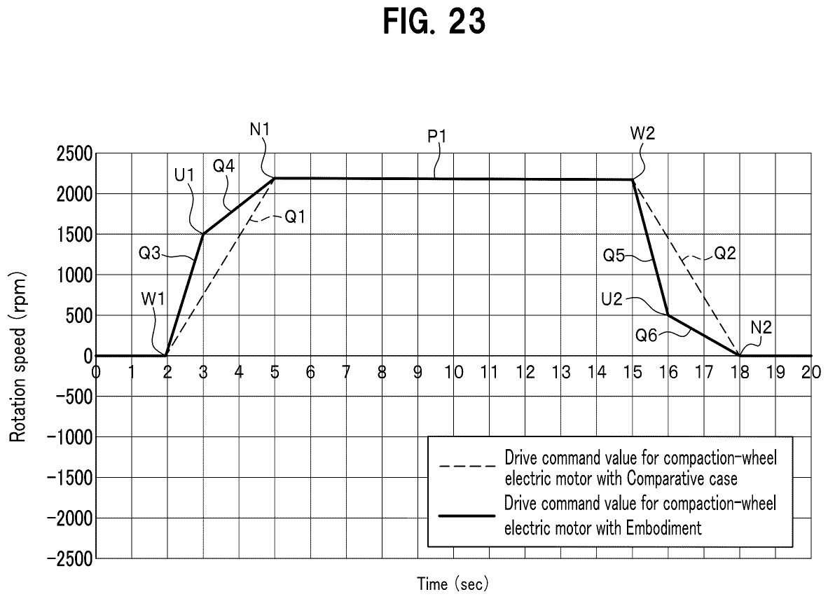

FIG. 23 shows a chart indicating the drive command values for the compaction-wheel electric motors with the comparative case and the embodiment, as a relationship between time and rotation speed. A solid line indicates the drive command value for the compaction-wheel electric motor with the embodiment. A dotted line indicates the drive command value for the compaction-wheel electric motor with the comparative case.

As shown by the solid line in FIG. 23, the drive command value for the compaction-wheel electric motor at a start time with the embodiment is composed of an acceleration shift point U1, as well as a first stage acceleration Q3 and a second stage acceleration Q4. An inclination (acceleration) of the first stage acceleration Q3 is larger (steeper) than that of the first stage acceleration Q1 with the comparative case. In contrast, an inclination of the second stage acceleration Q4 is smaller (more gradual) than that of the first stage acceleration Q1 with the comparative case.

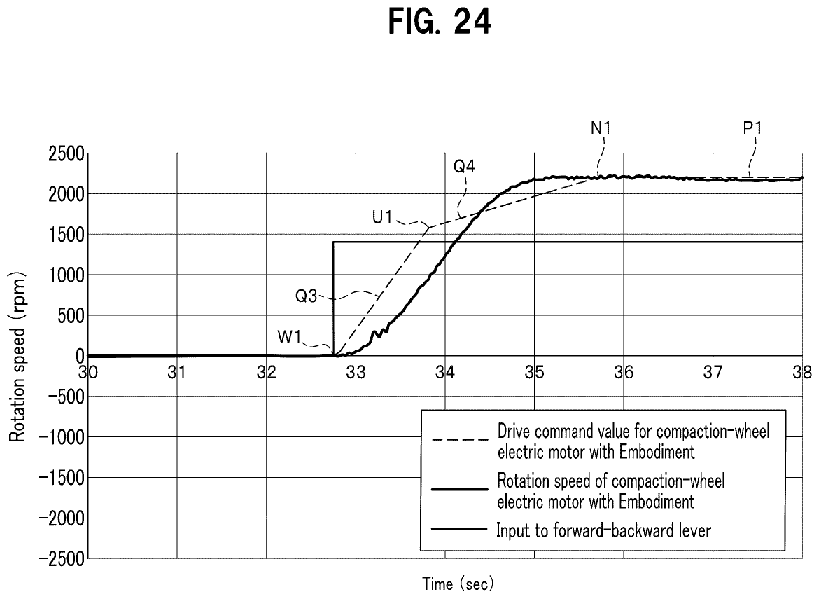

FIG. 24 shows a chart indicating a relationship between time and rotation speed at a start time with the embodiment. In FIG. 24, a dotted line indicates the drive command value for the compaction-wheel electric motor with the embodiment. A solid line indicates the rotation speed of the compaction-wheel electric motor with the embodiment. The drive command value for the compaction-wheel electric motor with the embodiment is set to 2200 rpm also as the aimed drive command value P1 and the rotation speed is set to reach the aimed drive command value P1 in 3.0 seconds since an input to the forward-backward lever 17.

As shown in FIG. 24, the inclination of the second stage acceleration Q4 to the aimed acceleration rotation speed N1 at a start time with the embodiment is smaller (more gradual) than that of the first stage acceleration Q1 with the comparative case. More specifically, the inclination of the first stage acceleration Q3 at a start time with the embodiment is larger than that of the first stage acceleration Q1 (see FIG. 23) with the comparative case, meaning the rotation speed of the compaction-wheel electric motor increases more rapidly as compared with the comparative case. The rotation speed then reaches the aimed drive command value P1 at the second stage acceleration Q4 more gradually as compared with the comparative case. This allows the compaction-wheel electric motor to reach the aimed drive command value P1 without excessive rotation (or with less excessive rotation). Accordingly, vehicle behavior stabilizes during acceleration.

### <Excessive Rotation Prevention Mechanism for Compaction-Wheel Electric Motor: at Stop Time>

As shown by the solid line in FIG. 23, the drive command value for the compaction-wheel electric motor at a stop time with the embodiment is composed of a deceleration shift point U2, as well as a first stage deceleration Q5 and a second stage deceleration Q6. An inclination (deceleration) of the first stage deceleration Q5 is larger (steeper) than that of the first stage deceleration Q2 with the comparative case. In contrast, an inclination of the second stage deceleration Q6 is smaller (more gradual) than that of the first stage deceleration Q2 with the comparative case.

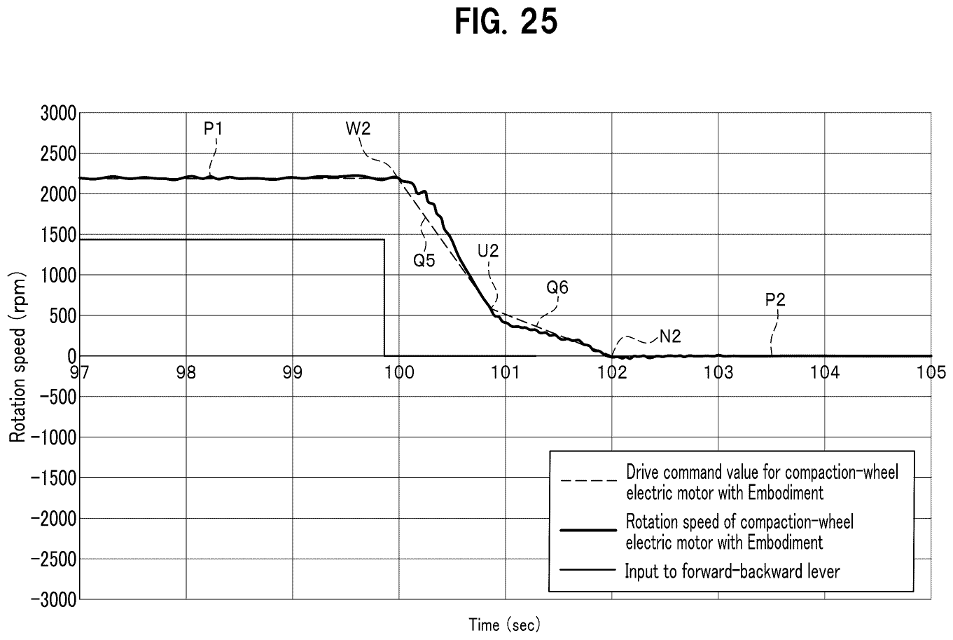

FIG. 25 shows a chart indicating a relationship between time and rotation speed at a stop time with the embodiment. In FIG. 25, a dotted line indicates the drive command value for the compaction-wheel electric motor with the embodiment. A solid line indicates the rotation speed of the compaction-wheel electric motor with the embodiment. With the embodiment, the aimed drive command value P2 is set to 0 rpm and the rotation speed is set to reach the aimed drive command value P2 in 2.0 seconds since the forward-backward lever 17 having returned to the neutral position.

As shown in FIG. 25, the inclination of the second stage deceleration Q6 to the aimed deceleration rotation speed N2 at a stop time with the embodiment is smaller (more gradual) than that of the first stage deceleration Q2 with the comparative case. More specifically, the inclination of the first stage deceleration Q5 at a stop time with the embodiment is larger than that of the first stage deceleration Q2 (see FIG. 23) with the comparative case, meaning the rotation speed of the compaction-wheel electric motor decreases more rapidly as compared with the comparative case. The rotation speed then reaches the aimed drive command value P2 gradually at the second stage deceleration Q6. This allows the compaction-wheel electric motor to reach the aimed drive command value P2 without excessive rotation (or with less excessive rotation). Accordingly, the vehicle is prevented from swinging back during deceleration to stabilize vehicle behavior.

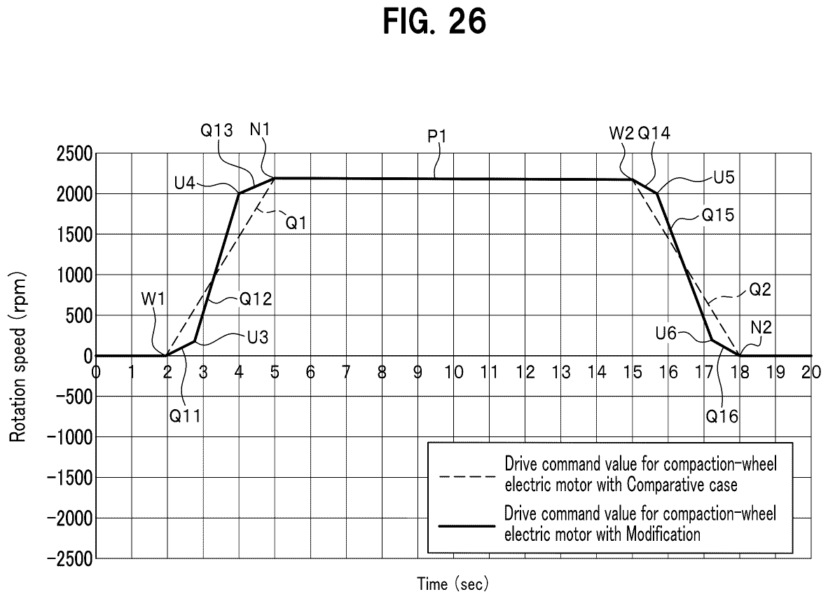

FIG. 26 shows a chart indicating a drive command value for the compaction-wheel electric motor with a modification, as a relationship between time and rotation speed. As shown in FIG. 26, acceleration or deceleration with the modification is executed in three stages. As shown by a solid line in FIG. 26, the drive command value for the compaction-wheel electric motor at a start time with the modification is composed of shift points U3 and U4, as well as a first-stage acceleration Q11, a second stage acceleration Q12, and a third stage acceleration Q13. The third stage acceleration Q13 extends to the aimed acceleration rotation speed N1. An inclination of the third stage acceleration Q13 is smaller (more gradual) than that of the first stage acceleration Q1 with the comparative case. This prevents the compaction-wheel electric motor from being excessively rotated, as with the second embodiment.

As shown by the solid line in FIG. 26, the drive command value for the compaction-wheel electric motor at a stop time with the modification is composed of shift points U5 and U6, as well as a first stage deceleration Q14, a second stage deceleration Q15, and a third stage deceleration Q16. The third stage deceleration Q16 extends to the aimed deceleration rotation speed N2. An inclination of the third stage deceleration Q16 is smaller (more gradual) than that of the first stage deceleration Q2 with the comparative case. This prevents the compaction-wheel electric motor from being excessively rotated, as with the second embodiment. Two or more shift points may be provided at a start time and/or a stop time, as with the modification.

As described above, the excessive rotation prevention mechanism for the compaction-wheel electric motor is configured such that the drive command value for the compaction-wheel electric motor has at least one shift point to set an inclination of the drive command value to each of the aimed acceleration rotation speed N1 and aimed deceleration rotation speed N2 smaller than that with the comparative case. Accordingly, the control unit 3 outputs signals to the compaction-wheel inverter in two or more stages of each of an acceleration range and a deceleration range, so that the aimed rotation speed of the compaction-wheel electric motor is gradually reached.

When an inclination of the drive command value to each of the aimed acceleration rotation speed N1 and aimed deceleration rotation speed N2 is set, the excessive rotation prevention mechanism for the compaction-wheel electric motor according to the present embodiment is configured such that a reference inclination (here, an inclination to each of the first stage acceleration Q1 and first-stage deceleration Q2 with the comparative case) is specified based on each of the aimed acceleration rotation speed N1 and aimed deceleration rotation speed N2, and then the inclination is set so as to be smaller (more gradual) than the reference inclination. The excessive rotation prevention mechanism may be configured to set the drive command value for the compaction-wheel electric motor based on a drive command value file including values set in advance according to tilt angles of the forward-backward lever 17. The drive command value file is a data file including shift points set in advance according to tilt angles of the forward-backward lever 17, aimed drive command values, time required to reach, and the like, for example. The drive command value file is stored in the storage unit of the control unit 3. Alternatively, the excessive rotation prevention mechanism may be configured such that the control unit 3 derives the drive command value for the compaction-wheel electric motor as appropriate, through calculation based on the detected tilt angle of the forward-backward lever 17, for example.

### Third Embodiment

### <Excessive Rotation Prevention Mechanism for Vibration Electric Motor>

Next, a description is given of a third embodiment of the present invention. The electric roller 1 according to the third embodiment is different from that of the first embodiment on the point that the former includes an excessive rotation prevention mechanism for the vibration electric motor to prevent excessive rotation of the vibration electric motor M4 in the vibration system. The third embodiment is to be described, focusing on differences from the first embodiment.

### <Issues>

As the vibration shaft 130 includes the eccentric weight 134, the vibration electric motor M4 may also be excessively rotated with respect to the aimed drive command value when vibration is started and stopped, as with the second embodiment. This causes vehicle behavior to be unstable, to make the operator OP feel uncomfortable.

### <Configuration of Excessive Rotation Prevention Mechanism for Vibration Electric Motor>

An excessive rotation prevention mechanism for the vibration electric motor is configured to set one or more shift points in the drive command value to be outputted from the control unit 3 to the vibration inverter J4. The way of setting the shift point is the same as that with the second embodiment, and thus is not described in detail. The control unit 3 outputs signals to the vibration inverter J4 in two or more stages of an acceleration range, when vibration is started, to make rotation speed of the vibration electric motor M4 gradually reach the aimed rotation speed. Accordingly, the rotation speed of the vibration electric motor M4 gradually reaches the aimed rotation speed, to reduce unstable vibration behavior due to excessive rotation.

In addition, when the vibration is stopped, the control unit 3 outputs signals to the vibration inverter J4 in two or more stages of a deceleration range, to gradually stop vibration. Accordingly, the vibration shaft 130 is prevented from being swung back, to allow for stably stopping the vibration shaft 130.

Hereinabove, the embodiments of the present invention have been described, but design can be changed as appropriate within the scope of the present invention.

### LEGEND FOR REFERENCE NUMERALS

1, electric roller; 2, vehicle frame; 3, control unit (VCU); 11, front frame; 12, rear frame; 17, forward-backward lever; 18, display; 19, steering; 51, orbit roll; 52, electric hydraulic pump; 53, filter; 54, accumulator; 55, hydraulic cylinder; 61, power-on brake; 62, power-off brake; 63, release lever; 71, battery management unit (BMU); J, inverter; K, battery; K1, 48 V battery; K2, 24 V battery; K3, 12 V battery; M, electric motor; R1, front wheel; and R2, rear wheel.

1. An electric roller comprising:
a pair of front and rear compaction wheels;
a vehicle frame rotatably supporting the compaction wheels;
at least one compaction-wheel electric motor to drive the compaction wheels;
a compaction-wheel inverter to control rotation speed of the compaction-wheel electric motor;
at least one battery to supply power to the compaction-wheel electric motor and compaction-wheel inverter; and
a control unit to output a signal to the compaction-wheel inverter according to a degree of inclination of a forward-backward lever,
wherein the electric roller has no internal combustion engine and uses only the battery as a power source for the compaction wheels.

2. The electric roller according to claim 1, wherein
the at least one compaction-wheel electric motor comprises two or more compaction-wheel electric motors.

3. The electric roller according to claim 1 or 2, wherein
the electric roller includes a potentiometer to detect a degree of inclination of the forward-backward lever, and outputs a detection result to the control unit.

4. The electric roller according to any one of claims 1 to 3, wherein
the control unit outputs signals to the compaction-wheel inverter in two or more stages of an acceleration range, so that an aimed rotation speed of the compaction-wheel electric motor is gradually reached.

5. The electric roller according to any one of claims 1 to 4, wherein
the control unit outputs signals to the compaction-wheel inverter in two or more stages of a deceleration range, to gradually stop the electric roller.

6. The electric roller according to any one of claims 1 to 5, wherein
the electric roller is equipped with electrical components including a lamp and an alarm, and the at least one battery comprises two or more batteries having different voltages from each other and electrically connected to the compaction-wheel electric motor and the electrical components, respectively.

7. The electric roller according to any one of claims 1 to 6, wherein
the battery is provided in at least one of a front space and a rear space of the vehicle frame.

8. The electric roller according to any one of claims 1 to 7, wherein
the electric roller is configured such that the electrical components, including the lamp, work even when the control unit has a system failure.

9. The electric roller according to any one of claims 1 to 8, wherein
a display provided on a dashboard displays a speedometer, along with vehicle information kept in the control unit.
